(19) United States
(12) Patent Application Publication
(10) Pub. No.: US 2015/0242266 A1
(43) Pub. Date: Aug. 27, 2015

(54) INFORMATION PROCESSING APPARATUS, CONTROLLER, AND METHOD FOR COLLECTING LOG DATA

(71) Applicant: FUJITSU LIMITED, Kawasaki-shi (JP)

(72) Inventors: Yuzo KORI, Kawasaki (JP); Shinnosuke Matsuda, Kawasaki (JP)

(21) Appl. No.: 14/611,295

(22) Filed: Feb. 2, 2015

(30) Foreign Application Priority Data
Feb. 26, 2014 (JP) 2014-035549

(51) Int. Cl. G06F 11/07

(52) U.S. Cl. CPC G06F 11/0787; G06F 11/0721

(57) ABSTRACT

A controller includes: a monitor that monitors an occurrence of a failure in a processor; an information obtainer that obtains, when the monitor detects the occurrence of the failure, log data from the device; and a first storing processor that stores the log data obtained by the information obtainer into a first storing device.

### CROSS-REFERENCE TO RELATED APPLICATION

This application is based upon and claims the benefit of priority of the prior Japanese Patent application No. 2014-035549, filed on Feb. 26, 2014, the entire contents of which are incorporated herein by reference.

### FIELD

The embodiment discussed herein is an information processing apparatus, a controller, and a method of collecting log data.

### BACKGROUND

In one of the known Controller Modules (CMs) included in storage devices, the Central Processing Unit (CPU) in the CM collects log data related to devices included in the CM. In the event of an occurrence abnormality in a device or a bus of such a CM, the suspect point of the abnormality can be specified by analyzing the collected log data.

The accompanying drawing FIG. 9 illustrates a procedure of collecting log data in a CM included in a traditional storage device.

In FIG. 9, two CMs (CMs #0, #1) 30 included in a storage device appear.

Hereinafter, when one of the two CMs needs to be specified, the CM is represented by “CM #0” or “CM #1”, but an arbitrary CM is represented by “CM 30”.

Each CM 30 includes a Field-Programmable Gate Array (FPGA) 31, a CPU 32, and a Non-Volatile Random Access Memory (NVRAM; non-volatile memory) 33.

In addition the FPGA 31, the CPU 32, and the NVRAM 33, the CM #0 includes three devices (devices #0-#2) and a switch (SW) 35.

Hereinafter, when one of the three devices needs to be specified, the device is represented by “device #0”, “device #1”, or “device #2”, but an arbitrary device is represented by the “device 34”.

The FPGA 31 of the CM #0 is communicably connected to the FPGA 31 of the CM #1 via inter-FPGA communication. In each CM 30, the FPGA 31 and the CPU 32 therein are communicably connected to each other via, for example, a bus, and likewise, the FPGA 31 and the NVRAM 33 therein are communicably connected to each other via, for example, a bus.

In the CM #0, the CPU 32 includes three high-speed interfaces (IFs) 321 and a low-speed IF 322, and each device 34 includes a high-speed IF 341 and a low-speed IF 342. The high-speed IFs 321 of the CPU 32 are communicably connected one to each of the high-speed IFs 341 of the devices 34 through a high-speed data communication buses while the low-speed IF 322 of the CPU 32 is communicably connected to the low-speed IFs 342 of the devices 34 through a low-speed log obtaining bus interposing the SW 35.

The CPU 32 of the CM #0 serves as a master of obtaining log data, and accesses each device 34, which serves as a slave via the low-speed log obtaining bus, to obtain the log data from the device 34. The obtained log data is to be used in, for example, analysis of the cause of a possible failure.

[Patent Literature 1] Japanese Laid-open Patent Publication No. 10-207742

[Patent Literature 2] Japanese Laid-open Patent Publication No. 05-165657

In the example of FIG. 9, the failure is occurring on the high-speed data communication bus between the high-speed IF 321 of the CPU 32 of the CM #0 and the high-speed IF 341 of the device #0 (see, reference number C1). Then, the failure propagates to the CPU 32 to make the CPU 32 into a hang-up state (see reference number C2).

In the event of the CPU 32 made into the hang-up state, the CPU 32 comes to be incapable of obtaining log data from the devices 34 through the respective low-speed log obtaining buses, so that the suspect point is disadvantageously not specified.

### SUMMARY

With the foregoing problems in view, there is provided an information processing apparatus including a controller communicably connected to a device to be monitored, the controller including: a monitor that monitors an occurrence of a failure in a processor; an information obtainer that obtains, when the monitor detects the occurrence of the failure, log data from the device; and a first storing processor that stores the log data obtained by the information obtainer into a first storing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating an example of the functional configuration of a storage system according to an example of a first embodiment;

FIG. 2 is a diagram illustrating an example of the detailed functional configuration of an FGPA included in a storage device of an example of the first embodiment;

FIG. 3 is a diagram illustrating an example of collecting of log data by a CM included in a storage device of an example of the first embodiment;

FIG. 4 is a diagram illustrating transmitting and receiving of log data in a storage device of an example of the first embodiment;

FIG. 5 is a diagram illustrating an example of a packet used in a storage device of an example of the first embodiment;

FIG. 6 is a diagram illustrating an example of a packet used in a storage device of an example of the first embodiment;

FIG. 7 is a flow diagram illustrating a succession of procedural steps of collecting log data in a storage device of an example of the first embodiment;

FIG. 8 is a sequence diagram illustrating an example of a succession of procedural steps of collecting log data in a storage device of an example of the first embodiment; and

FIG. 9 is a diagram illustrating an example of collecting of log data by a CM included in a traditional storage device.

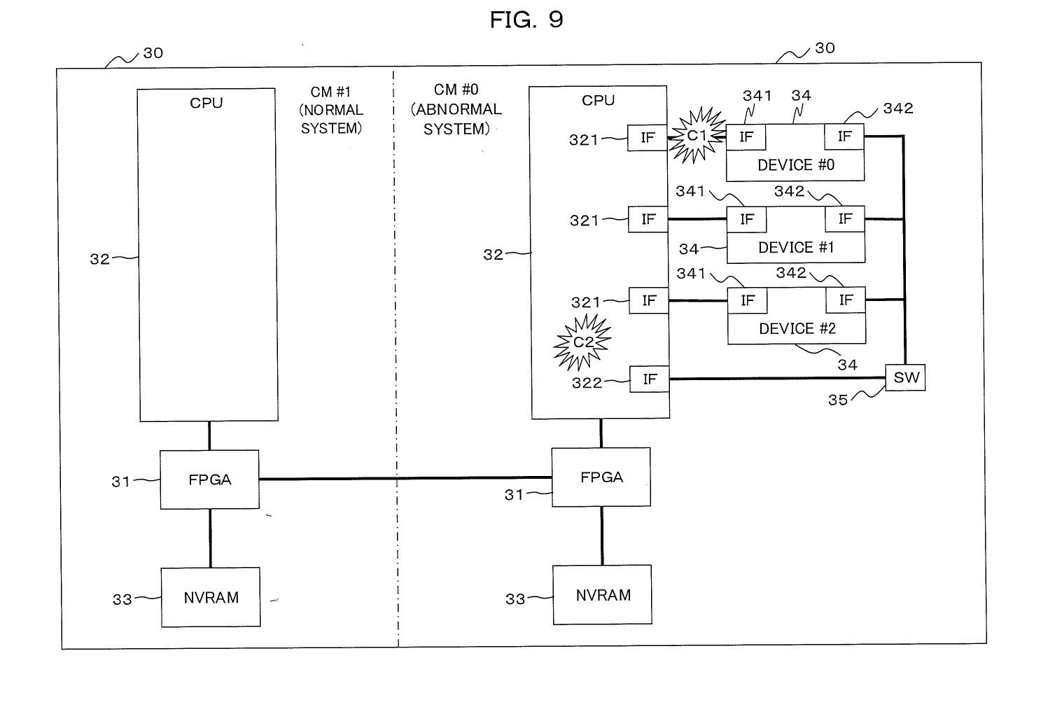

### DESCRIPTION OF EMBODIMENTS

Hereinafter, description will now be made in relation to a storage device, a controller, and a method of collecting log data with reference to the accompanying drawings. However, the following embodiment is merely exemplary and has no intention to exclude various modification and application of techniques that are not explained throughout the description. In other words, various changes and modifications can be suggested without departing from the spirit of the embodiment.

The drawings do not illustrate therein all the functions and elements included in the embodiment. The embodiment may include additional functions and elements to those illustrated in the accompanying drawings.

Hereinafter, like reference numbers designate similar parts and elements throughout the drawings, so repetitious description is omitted here.

### (A) Example of First Embodiment

(A-1) System Configuration:

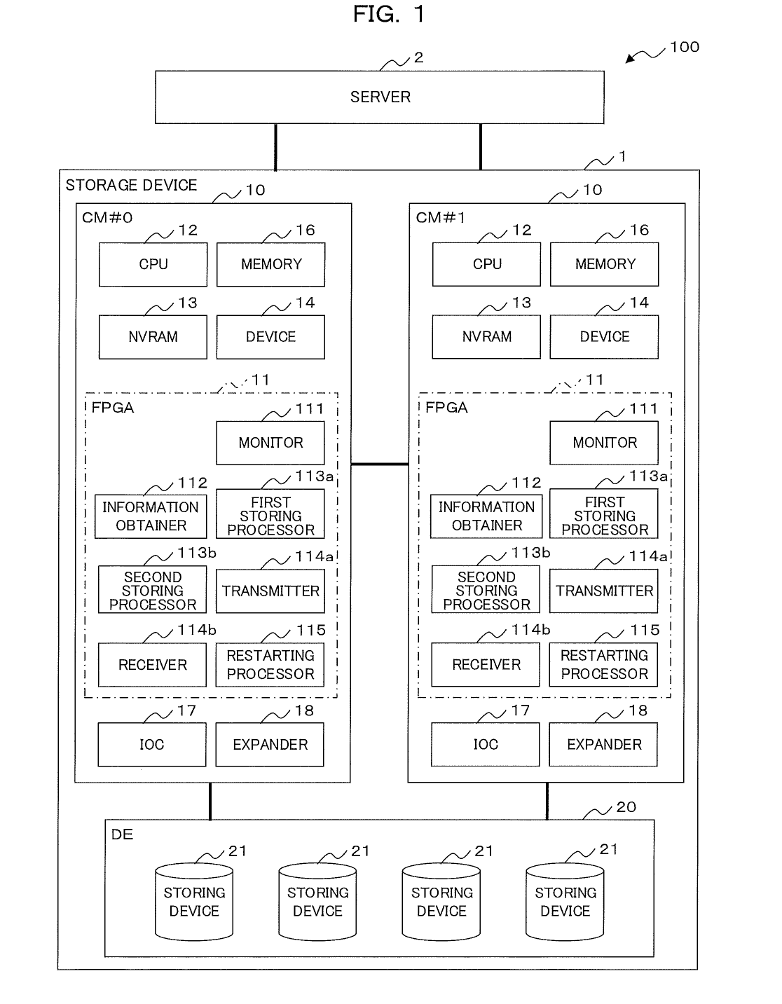

FIG. 1 is a diagram schematically illustrating the functional configuration of a storage system according to an example of the first embodiment.

As illustrated in FIG. 1, a storage system 100 of an example of the first embodiment includes a storage device (information processing apparatus) 1 and a server 2, which are communicably connected to each other via, for example, a Local Area Network (LAN).

An example of the server 2 is a computer having a server function. In the example of FIG. 1, the storage system 100 includes a single server 2, but may alternatively include two or more servers 2.

The storage device 1 includes multiple storing devices 21 that are to be detailed below, and provides a memory region to the server 2. For example, the storage device 1 disperses data in the multiple storing devices 21 using a technique of the Redundant Arrays of Inexpensive Disks (RAID) and stores the data keeping the data redundancy. The storage device 1 of an example of the first embodiment includes multiple (two in the illustrated example) CMs 10 (CM #0, CM #1; controller) and a Disk Enclosure (DE) 20.

Hereinafter, when one of the two CMs needs to be specified, the CM is represented by a “CM #0” or “CM #1”, but an arbitrary CM is represented by a “CM 10”.

The redundant configuration of the storage device 1 that includes two CMs 10 makes the storage device 1 possible to keep its operation by using the secondary CM 10 (e.g., the CM #1) even when the primary CM 10 (e.g., the CM #0) fails into an abnormal state.

For the redundancy, the DE 20 is communicably connected to the CM #0 and CM #1 via respective access paths, and includes multiple (four in the illustrated example) storing devices 21.

A storing device 21 is an existing device that readably and writably stores data therein and is exemplified by a Hard Disk Drive (HDD) or a Solid State Drive (SSD). These storing devices 21 are the same in configuration and function as one another.

A CM 10 is a controller responsible for various controls and carries out various controls in response to storage access commands (access control signals; hereinafter called host I/O) issued from the server 2. Each CM 10 of an example of the first embodiment includes an FPGA 11, a processor (CPU) 12, a non-volatile memory (NVRAM, a first storing device, a second storing device) 13, a device (device to be monitored, monitoring target device) 14, a memory 16, an Input/Output Controller (IOC) 17, and an expander 18.

The IOC 17 executes data forwarding between the CPU 12 and the DE 20 and is exemplified by a dedicated microchip.

The expander 18 is a relay between the local CM 10 and the DE 20, and executes data forwarding based on a host I/O. In other words, each CM 10 accesses the storing devices 21 included in the storage device 1 via the expander therein.

The device 14 can be any device installed in the CM 10. In the example of FIG. 1, each CM 20 includes only one device 14 for simplifying the drawing, but may alternatively include multiple devices 14. A device 14 maybe disposed on the board of the CM 10 or may be an add-in card such as a Peripheral Component Interconnect (PCI) card which makes itself communicable with the CM 10.

The non-volatile memory 13 is exemplified by a NAND flash memory or a Serial Advanced Technology Attachment Solid State Drive (SATA SSD), and can keep retaining data even after the power supply to the CM 10 is stopped. In an example of the first embodiment, the non-volatile memory 13 stores therein log data (system data) obtained from the device 14.

The memory 16 is a storing device including a Read Only Memory (ROM) and a Random Access Memory (RAM). In the ROM of the memory 16, a program such as the Basic Input/Output System (BIOS) is written. The software programs stored in the memory 16 are read by the CPU 12, which then executes the program. The RAM of the memory 16 is, for example, a Double-Data-Rate3 Synchronous Dynamic Random Access Memory (DDR3 SDRAM) and is used as a primary recording memory or a working memory.

The CPU 12 is a processor responsible for various controls and calculations, and specifically achieves various functions through executing the Operating System (OS) or programs stored in the memory 16.

The program (controlling program) that achieves the various functions is provided in the form of being recorded in a tangible and non-transitory computer-readable storage medium, such as a flexible disk, a CD (e.g., CD-ROM, CD-R, and CD-RW), a DVD (DVD-ROM, DVD-RAM, DVD-R, DVD+R, DVD-RW, DVD+RW, and HD DVD), a Blu-ray disk, a magnetic disk, an optical disk, and an magneto-optical disk. A computer reads the program from the recording medium using a non-illustrated medium reader and stores the read program in an internal or external storage device for future use. Alternatively, the program may be recorded in a recording device (recording medium), such as a magnetic disk, an optical disk, or a magneto-optical disk, and may be provided from the recording device to the computer via a communication path.

Further alternatively, in achieving the various functions, the program stored in the internal storage device (corresponding to the memory 16 of the first embodiment) is executed by the microprocessor (corresponding to the CPU 12 in the first embodiment) of the computer. For this purpose, the computer may read the program stored in the recording medium and execute the program.

The FPGA 11 is an integrated circuit that can be arbitrarily configured, and as illustrated in FIG. 1, functions as a monitor 111, an information obtainer 112, a first storing processor 113a, a second storing processor 113b, a transmitter 114a, a receiver 114b, and a restarting processor 115. In an example of the first embodiment, the FPGA 11 of the CM #0 and the FPGA 11 of the CM #1 are communicably connected to each other via, for example, inter-FPGA communication.

The monitor 111 monitors the CPU 12 in the same CM 10, and detects a possible failure occurred in the CPU 12.

In cases where the monitor 111 detects a failure occurrence in the CPU 12, the information obtainer 112 obtains log data from the device 14.

The first storing processor 113a stores the log data obtained by the information obtainer 112 into the non-volatile memory 13.

The FPGA 11 (CM 10) has multiple kinds of non-illustrated recovering functions including processes of Non-Maskable Interrupt (NMI; processor preemptive process), software reset (soft reset), and hardware reset (hard reset). The FPGA 11 (CM 10) repetitiously causes the information obtainer 112 to obtain log data and causes the first storing processor 113a to store the log data at, for example, multiple timings of above recovery processes. In other words, the non-volatile memory 13 stores therein multiple pieces of log data related to the above various recovery processes.

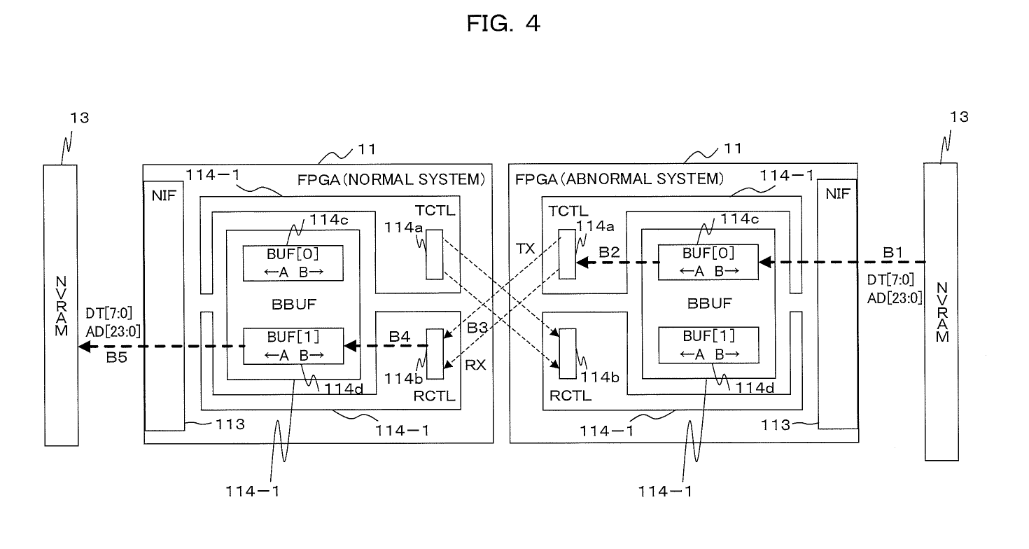

The transmitter 114a transmits log data obtained by the information obtainer 112 to the foreign CM 10. For example, the transmitter 114a of the CM #0 transmits the log data obtained by the information obtainer 112 to the CM #1 via the inter-FPGA communication. Specifically, after hang-up (disable state) of the CPU 12 is established, the transmitter 114a transmits the multiple pieces of log data stored in the non-volatile memory 13 to the foreign CM 10. The detailed transmitting of the log data by the transmitter 114a will be detailed below with reference to FIG. 4.

The receiver 114b receives log data transmitted by another CM 10. For example, the receiver 114b of the CM #1 receives log data that the CM #0 has transmitted via the inter-FPGA communication.

The second storing processor 113b stores log data received by the receiver 114b into the non-volatile memory 13.

After the transmitter 114a transmits the log data to another CM 10, the restarting processor 115 restarts the (local) CM 10 incorporating the same restarting processor 115. Alternatively, the restarting processor 115 may restart only the device 14 and the CPU 12 where the failure occurs (suspect point) and the failure propagates both included in in the local CM 10.

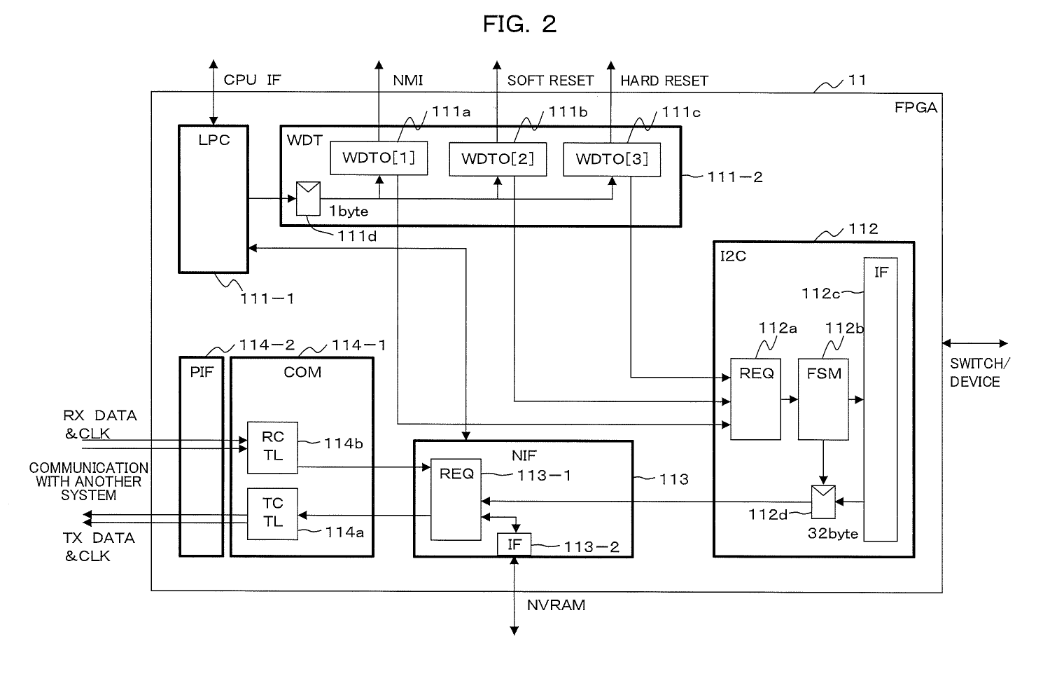

FIG. 2 is a diagram illustrating the detailed functional configuration of an FPGA included in the storage device of an example of the first embodiment.

The FPGA 11 illustrated in FIG. 2 includes modules of a Low Pin Count bus (LPC) 111-1, a Watch Dog Timeout (WDT) 111-2, an Inter-Integrated Circuit (I2C) 112, a NVRAM Interface (NIF) 113, a Communication (COM) 114-1, and a Protocol Interface (PIF) 114-2.

The LPC 111-1 and the WDT 111-2 correspond to the function of the monitor 111 illustrated in FIG. 1.

The LPC 111-1 carries out interface control to allow the CPU 12 to access the FPGA 11.

The WDT 111-2 includes various modules of a Watch Dog Timeout 1 (WDTO[1]) 111a, a WDTO[2] 111b, a WDTO[3] 111c, and a register 111d. The CPU 12 periodically writes data into, for example, the 1-byte register 111d (issues a watch dog write to the register 111d) via the LPC 111-1. Thereby, the WDT 111-2 recognizes that the CPU 12 normally operates.

In cases where data writing into the register 111d is not carried out for a predetermined time (i.e., the watch dog time [1] expires), the WDTO[1] 111a issues an NMI to the CPU 12 and issues a request to obtain the log data to the I2C 112.

In cases where data writing into the register 111d is not carried out for a predetermined time (i.e., the watch dog time [2] expires), the WDTO[2] 111b issues an instruction of software reset (soft reset) to the CPU 12 and issues a request to obtain the log data to the I2C 112.

In cases where data writing into the register 111d is not carried out for a predetermined time (i.e., the watch dog time [3] expires), the WDTO[3] 111c issues an instruction of hardware reset (hard reset) to the CPU 12 and issues a request to obtain the log data to the I2C 112.

The multiple pieces of log data obtained in response to requests from the WDTO[1] 111a, the WDTO[2] 111b, and the WDTO[3] 111c are called log data [1], log data [2], and log data [3], respectively.

The I2C 112 corresponds to the function of the information obtainer 112 illustrated in FIG. 1 and includes modules of a Request (REQ) 112a, a Finite State Machine (FSM) 112b, an IF 112c, and a register 112d.

Upon receipt of request to obtain log data from the WDTO[1] 111a, the WDTO[2] 111b, or the WDTO[3] 111c, the REQ 112a controls the log data obtaining request.

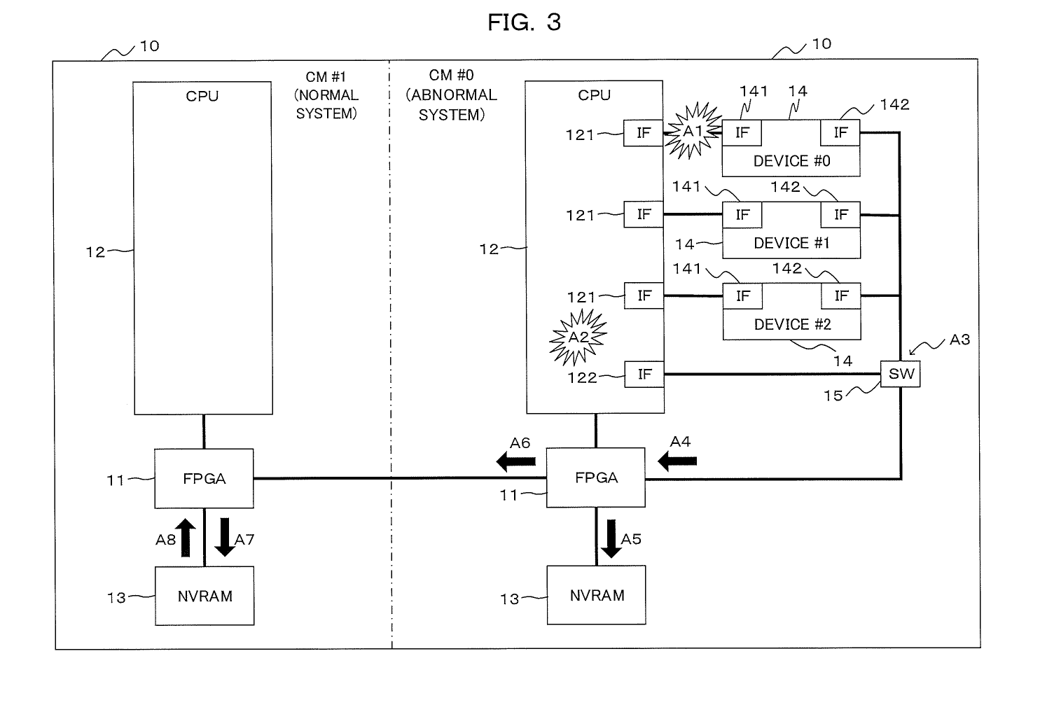

The FSM 112b switches between ON/OFF of the switch 15 (SW, to be detailed below by referring to FIG. 3) on the basis of the control on the log data obtaining request of the REQ 112a and thereby manages the status of the data reading cycle. In other words, the FSM 112b carries out switch control and thereby makes the route through which the FPGA 11 carries out I2C control available.

The IF 112c carries out I2C interface control. Specifically, the IF 112c obtains log data [1]-[3] each having a size of, for example, one kilobyte from one or more (thee in the example to be described below by referring to FIG. 3) devices 14.

The I2C 112 sequentially stores the log data obtained from each device 14 via the IF 112c into the register 112d having a size of, for example, 32 bytes and then sequentially forwards the stored log data to the NIF 113 in a unit of, for example, eight bytes.

The NIF 113 corresponds to the functions of the first storing processor 113a and the second storing processor 113b illustrated in FIG. 1. The NIF 113 carries out NVRAM (non-volatile memory) control and includes modules of a REQ 113-1 and an IF 113-2.

The REQ 113-1 accepts a request to write/read data into/from the NVRAM 13. Examples of requests acceptable by the REQ 113-1 are Write from OwnCM (I2C), Write from OtherCM (COM), Write to OtherCM (COM), and Read from CPU.

“Write from OwnCM (I2C)” is a request to store log data [1]-[3] obtained from the respective devices 14 via the I2C 112 into the NVRAM 13 in the local CM 10. “Write from OtherCM (COM)” is a request to store log data [1]-[3] received from the foreign CM 10 via the COM 114-1 into the NVRAM 13. “Write to OtherCM (COM)” is a request to forward log data [1]-[3] obtained in the local CM 10 to the foreign CM 10. “Read from CPU” is a request to read various data stored in the NVRAM 13 by the local CPU 12 via the LPC 111-1.

In cases where the REQ 113-1 accepts Write from OwnCM (I2C), the NIF 113 functions as the first storing processor 113a illustrated in FIG. 1. Specifically, upon received of the log data [1]-[3] from the I2C 112, the NIF 113 starts writing into the NVRAM 13. On the other hand, if the REQ 113-1 accepts Write from OtherCM (COM), the NIF 113 functions as the second storing processor 113b illustrated in FIG. 1. Specifically, upon receipt of the log data [1]-[3] from the COM 114-1, the NIF 113 starts writing into the NVRAM 13. After the completion of the obtaining and the writing to the NVRAM 13 of all the log data [1]-[3], the NIF 113 accepts Write to OtherCM (COM). Then, the NIF 113 reads log data [1]-[3] from the NVRAM 13 and starts forwarding the log data [1]-[3] to the other system (normal system).

The IF 113-2 carries out NVRAM interface control. The NIF 113 reads and writes the log data [1]-[3] from and into the NVRAM 13 via the IF 113-2.

The COM 114-1 carries out communication control with another system and includes modules of a Transmission Controller (TCTL) 114a and a Receive Controller (RCTL) 114b.

The TCTL 114a corresponds to the function of the transmitter 114a illustrated in FIG. 1 and carries out transfer control. Specifically, the TCTL 114a forwards the log data [1]-[3] received from the NIF 113 to the foreign CM 10 through the PIF 114-2. In the example illustrated in FIG. 2, the TCTL 114a regards the log data [1]-[3] as a transmission data (TX DATA) signal and transmits the transmission data signal along with a clock (CLK) signal.

The RCTL 114b corresponds to the function of the receiver 114b illustrated in FIG. 1 and carries out receiver control. Specifically, the RCTL 114b forwards the log data [1]-[3] received from the foreign CM 10 via the PIF 114-2 to the NIF 113. In the example illustrated in FIG. 2, the RCTL 114b receives a reception data (RX DATA) signal containing the log data [1]-[3] along with a clock (CLK) signal.

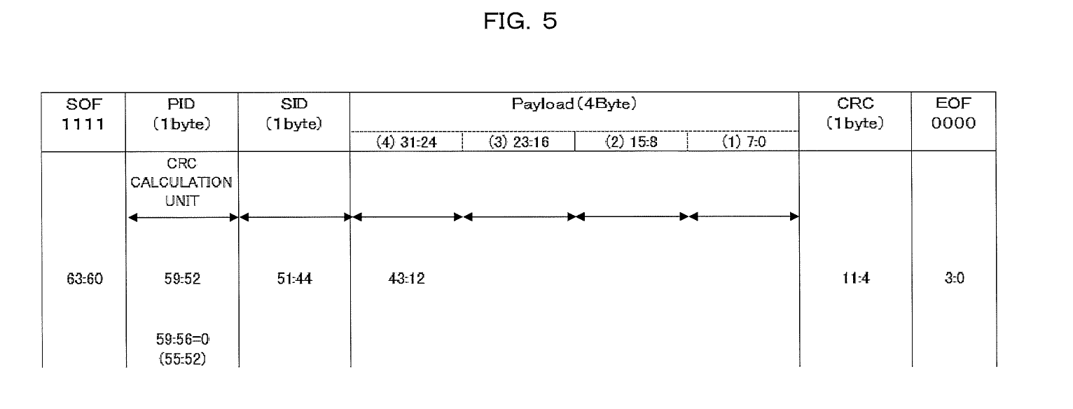

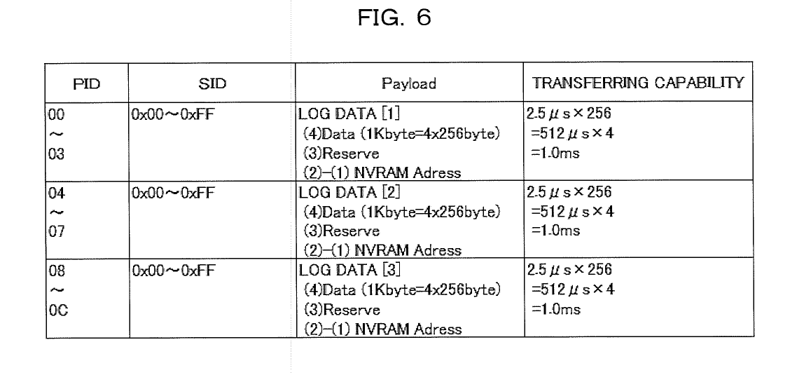

The PIF 114-2 carries out interface control of protocol for communication with another system. The packets to be used in interfacing control of protocol for communication with another system will be detailed below by referring to FIGS. 5 and 6.

The FPGA 11 further includes a module (not illustrated) corresponding to the function of the restarting processor 115 illustrated in FIG. 1. This module restarts the local CM 10 after the transmission of log data [1]-[3] to the other system (normal system) is completed.

FIG. 3 is a diagram illustrating an example of collecting of the log data by a CM included in the storage device according to an example of the first embodiment.

FIG. 3 illustrates an example of the CM #0 and the CM #1 included in the storage device 1 of an example of the first embodiment. In the example illustrated in FIG. 3, the CM #0 is assumed to bean abnormal system while the CM #1 is assumed to be a normal system.

For simplification of the drawing, FIG. 3 omits illustration of the device 14, the memory 16, the IOC 17, and the expander 18 included in the CM #1. The illustration of the memory 16, the IOC 17, and the expander 18 included in the CM #0 is also omitted and the CM #0 is assumed to include three devices (device #0-#2, monitoring target devices) 14, and a switch (SW) 15.

Hereinafter, when one of the three devices needs to be specified, the device is represented by the “device #0”, “device #1”, or “device #2” but an arbitrary device is represented by a “device 14”.

The FPGA 11 of the CM #0 is communicably connected with the FPGA 11 of the CM #1 via the inter-FPGA communication. In each CM 10, the FPGA 11 and the CPU 12 are communicably connected to each other via, for example, a bus, and the FPGA 11 and the NVRAM 13 are also communicably connected to each other via, for example, a bus.

The CPU 12 of the CM #0 includes three high-speed IFs 121, such as the Peripheral Component Interconnect Express (PCIe) or the Serial Attached Small computer system interface (SAS), and a low-speed IF 122. Each device 14 includes a high-speed IF 141 and a low-speed IF 142. The high-speed IFs 121 of the CPU 12 are communicably connected one to each of the high-speed IF 141 of each device 14 through a high-speed data communication bus while the low-speed IF 122 of the CPU 12 is communicably connected to the low-speed IF 142 of the devices through a low-speed log obtaining bus interposing the SW 15. Furthermore, the FPGA 11 of the CM #0 is communicably connected to the low-speed IF 142 of each device 14 through a low-speed log obtaining bus interposing the SW 15.

In the example illustrated in FIG. 3, a failure occurs on the high-speed data communication bus between the high-speed IF 121 of the CPU 12 of the CM #0 and the high-speed IF 141 of the device #0 (see, reference number A1). Then, the failure propagates to the CPU 12 to make the CPU 12 to be in a hang-up state (see reference number A2). In cases where the CPU 12 is in a hang-up state, the CPU 12 comes unable to collect the log data using a low-speed log obtaining bus, so that the log data is not obtained from each device 14.

As a solution to the above, in an example of the first embodiment, in cases where a hang-up of the CPU 12 occurs, the FPGA 11 being a hardware device automatically obtains the log data and transmits the obtained log data to the CM #1 being in the normal state.

Specifically, the FPGA 11 detects an occurrence of a failure in the CPU 12 and switches the route of the SW 15 that connects the CPU 12 to each device 14 via the low-speed log obtaining bus to a route that connects the FPGA 11 and each device 14 (see Arrow A3). In other words, in cases where any of the WDT[1] through WDT[3] described the above by referring to FIG. 2 expires, the FPGA 11 operates the SW 15 to disconnect the CPU 12 from the low-speed log obtaining bus.

The FPGA 11 obtains the log data from each device 14 (see Arrow A4), and stores the obtained log data into the NVRAM 13 (see Arrow A5). In other words, the FPGA 11 acts as a master in log-data obtaining and access the devices 14 acting as slaves via the log data obtaining bus to obtain the log data from the devices 14.

Here, since the failure occurs in the CPU 12 of the CM #0, the CM #0 being in the abnormal state is incapable of immediately analyzing the log data obtained by the FPGA 11. For the above, in cases where the CPU 12 recovers from the watch dog time out (the normal operation of the CPU 12 is confirmed) or in cases where the hang-up of the CPU 12 is established, the FPGA 11 reads the obtained log data from the NVRAM 13. Then, the FPGA 11 forwards the log data read from the NVRAM 13 to the foreign CM #1 being in the normal state via the inter-FPGA communication (see Arrow A6).

The FPGA 11 of the CM #1 being in the normal state receives the log data transmitted from the CM #0 being in the abnormal state, stores the received log data into the NVRAM 13 (see Arrow A7), and notifies the local CPU 12 of the completion of receiving the log data.

The CPU 12 of the CM #1 reads the log data from the local NVRAM 13 via the FPGA 11 (see Arrow A8), and stores the read log data, as device log, in, for example, the memory 16 (not illustrated in FIG. 3).

FIG. 4 is a diagram illustrating transmitting and receiving of log data in the storage device according to an example of the first embodiment.

FIG. 4 illustrates part of the functional configuration of the CM #0 and the CM #1 included in the storage device 1 of an example of the first embodiment. Specifically, FIG. 3 illustrates only the FPGA 11 and the non-volatile memory (NVRAM) 13 of each CM 10 among the functional configuration illustrated in FIG. 1. In the functional configuration of the FPGA 11 of each CM 10 illustrated in FIG. 2, only the NIF 113 and the COM 114-1 appear in FIG. 4.

In the example of FIG. 4, the COM 114-1 includes a buffer (BUF)[0] 114c and a buffer BUF[1] 114d in addition to the TCTL 114a and the RCTL 114b illustrated in FIG. 2. In other words, part of the COM 114-1 functions as a block buffer (BBUF), as illustrated in FIG. 4.

Upon accept of a Write to OtherCM (COM), the NIF 113 of the FPGA 11 in the abnormal system reads the log data from the NVRAM 13 and stores the read log data into the BUF[0] 114c of the COM 114-1 (see Arrow B1). The log data read from the NVRAM 13 has, for example, eight-bit (one-byte) data (DT) and a 24-bit (three-byte) address (AD).

The BUF[0] 114c forwards the stored log data to the TCTL 114a (see Arrow B2).

The TCTL 114a transmits the log data being in the form of a packet to be detailed below by referring to FIGS. 5 and 6 to the FPGA 11 in the normal system (see Arrow B3). The TCTL 114a transmits the packet as the TX_DATA and also a clock signal as TX_CLK.

The RCTL 114b of the FPGA 11 of the normal system receives packets transmitted from the FPGA 11 of the abnormal system, and stores the packets, as the log data, into the BUF[1] 114d (see Arrow B4). The RCTL 114b receives packets as RX_DATA and a clock signal as RX_CLK.

The BUF[1] 114d forwards the stored log data to the NIF 113. Upon accept of a Write from OtherCM (COM), the NIF 113 stores the log data into the NVRAM 13 (see Arrow B5). The log data to be written into the NVRAM 13 has, for example, eight-bit (one-byte) data (DT) and a 24-bit (three-byte) address (AD).

FIGS. 5 and 6 are diagrams illustrating packets used in the storage device of an example of the first embodiment.

As illustrated in FIG. 5, the packet used for transmitting and receiving log data in an example of the first embodiment is defined by 64 bits (eight bytes). Specifically, the 63rd to 60th bits are the Start Of Frame (SOF); the 59th to 52nd bits are a Packet ID (PID); the 51st to 44th bits are a Serial ID (SID); the 43rd to 12th bits are Payload (transmitted data); the 11th to 4th bits are Cyclic Redundancy Check (CRC; protection code); and the 3rd to 0th bits are an End Of Frame (EOF).

As illustrated in FIG. 5, the bit string “1111” is set in the SOF. As illustrated in FIG. 5, the value “0” is set each in the 59th-56th bits of the PID while as illustrated in FIG. 6, the values “00”-“0c” are set in the 55th-52nd bits of the PID, respectively. As illustrated in FIG. 6, the values “0x00”-“0xFF” are set in the SID.

As illustrated in FIG. 5, the Payload is divided into segments (4)-(1). The segments (4), (3), (2), and (1) correspond to the 31st-24th bits, the 23rd-16th bits, the 15th-8th bits, and the 7th-0th bits of the Payload, respectively. As illustrated in FIG. 6, when the PID is “00”-“03”, a one-KB data related to the log data [1] is stored in the segment (4) of the Payload; when the PID is “04”-“07”, a one-KB data related to the log data [2] is stored in the segment (4) of the Payload; and when the PID is “08”-“0C”, a one-KB data related to the log data [3] is stored in the segment (4) of the Payload. The segment (3) of the Payload is a reserve segment, and in the segments (2) and (1) of the Payload, the address in the NVRAM 13 is stored.

The six double-pointed arrows of FIG. 5 is the CRC calculation unit and the results of CRC calculation on the respective CRC calculation units are set in the CRC. As illustrated in FIG. 5, the value “0000” is set in the EOF.

The forwarding performance of packets used for transmitting and receiving the log data in an example of the first embodiment is 1.0 ms as denoted in FIG. 6.

(A-2) Operation:

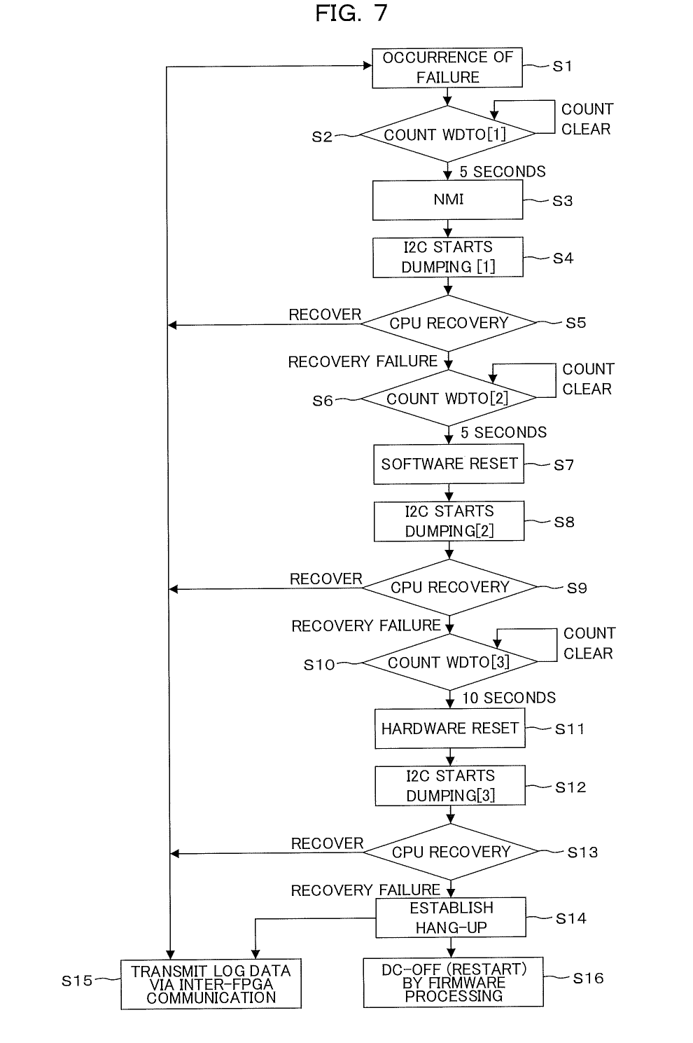

Description will now be made in relation to a procedure of collecting log data in the storage device of an example of the first embodiment having the above configuration by referring to the flow diagram FIG. 7 (steps S1-S16).

The WDT 111-2 detects an occurrence of a failure in the CPU 12 when not detecting the periodic wiring of the CPU 12 into the register 111d (step S1).

The WDTO[1] 111a counts the watch dog time [1] (step S2).

When the CPU 12 writes data into the register 111d within a predetermined time (e.g., five seconds) (see the “count clear” route of step S2), the WDTO[1] 111a clears the count of the watch dog time [1] and returns the procedure to step S2. In other words, the WDTO[1] 111a repeats counting of the watch dog time [1].

On the other hand, when the CPU 12 does not write data into the register 111d for the predetermined time (e.g., five seconds) (see the “five seconds” route of step S2), the WDTO[1 ] 111a issues an NMI to the CPU 12 (step S3).

The I2C 112 starts obtaining log data [1] (dumping [1]) from the devices 14 (e.g., devices #0-#2 illustrated in FIG. 3) (step S4).

The CPU 12 carries out the recovery (step S5).

In cases where the recovery successfully recovers the CPU 12 (see the “recovery” route of step S5), the TCTL 114a transmits the obtained log data [1] to the foreign FPGA 11 via the inter-FPGA communication (step S15) and returns the procedure to step S1 to be on stand-by.

On the other hand, in cases where the recovery fails (see the “recovery failure” route of step S5), the WDTO[2] 111b counts the watch dog time [2] (step S6).

When the CPU 12 writes data into the register 111d within a predetermined time (e.g., five seconds) (see the “count clear” route of step S6), the WDTO[2] 111b clears the count of the watch dog time [2] and returns the procedure to step S6. In other words, the WDTO[2] 111b recounts the watch dog time [2].

On the other hand, when the CPU 12 does not write data into the register 111d for the predetermined time (e.g., five seconds) (see the “five seconds” route of step S6), the WDTO[2 ] 111b issues an instruction of software reset to the CPU 12 (step S7).

The I2C 112 starts obtaining log data [2] (dumping [2]) from the devices 14 (e.g., devices #0-#2 illustrated in FIG. 3) (step S8).

The CPU 12 carries out the recovery (step S9).

In cases where the recovery successfully recovers the CPU 12 (see the “recovery” route of step S9), the TCTL 114a transmits the obtained log data [1] and [2] to the foreign FPGA 11 via the inter-FPGA communication (step S15) and returns the procedure to step S1 to be on stand-by.

On the other hand, in cases where the recovery fails (see the “recovery failure” route of step S9), the WDTO[3] 111c counts the watch dog time [3] (step S10).

When the CPU 12 writes data into the register 111d within a predetermined time (e.g., 10 seconds) (see the “count clear” route of step S10), the WDTO[3] 111c clears the count of the watch dog time [3] and returns the procedure to step S10. In other words, the WDTO[3] 111b recounts the watch dog time [3].

On the other hand, when the CPU 12 does not write data into the register 111d for the predetermined time (e.g., 10 seconds) (see the “10 seconds” route of step S10), the WDTO[3] 111c issues an instruction of hardware reset to the CPU 12 (step S11).

The I2C 112 starts obtaining log data [3] (dumping [3]) from the devices 14 (e.g., devices #0-#2 illustrated in FIG. 3) (step S12).

The CPU 12 carries out the recovery (step S13).

In cases where the recovery successfully recovers the CPU 12 (see the “recovery” route of step S13), the TCTL 114a transmits the obtained log data [1], [2], and [3] to the foreign FPGA 11 via the inter-FPGA communication (step S15) and returns the procedure to step S1 to be on stand-by.

On the other hand, in cases where the recovery fails (see the “recovery failure” route of step S13), the FPGA 11 determines the hang-up of the CPU 12 is established (step S14).

The TCTL 114a transmits the obtained log data [1], [2], and [3] to the foreign FPGA 11 via the inter-FPGA communication (step S15) and the FPGA 11 made the local CM 10 into the DC-OFF state through firmware processing (step S16). This means that the FPGA 11 restarts the local CM 10. Alternatively, the FPGA 11 may restart only the local device 14 and the local CPU 12 where the failure occurs (suspect point) and the failure propagates.

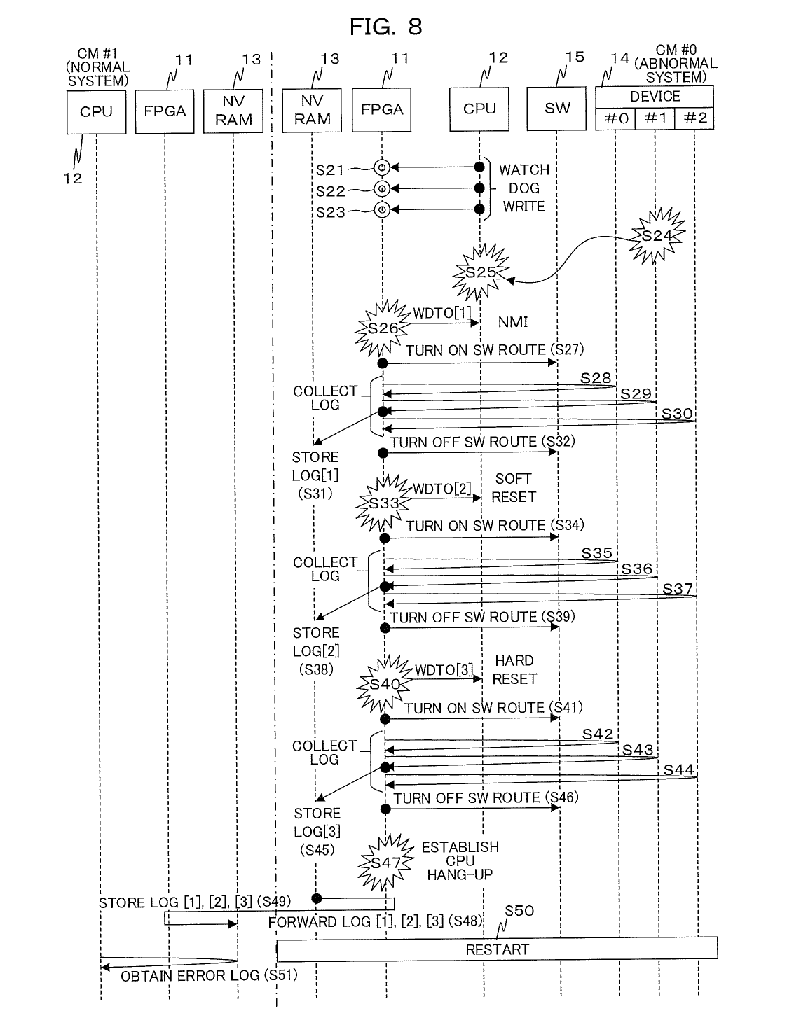

Next, description will now be made in relation to collecting of log data in the storage device according to an example of the first embodiment by referring to the sequence diagram of FIG. 8 (steps S21-S51).

The CM #0 and the CM #1 of FIG. 8 are the same in function and configuration as the CM #0 and CM #1 illustrated in FIG. 3, respectively. Here, the CM #0 and the CM #1 are assumed to be the abnormal system and the normal system, respectively.

The CPU 12 of the CM #0 periodically carries out watch dog write on the FPGA 11. The WDTO[1] 111a, WDTO[2] 111b, and WDTO[3] 111c of the FPGA 11 recognize that the CPU 12 normally operates by means of the watch dog write from the CPU 12 (steps S21-S23).

Under the above state, a failure occurs in the device #1 (step S24) and then propagates to the CPU 12 (step S25).

Expiration of the watch dog time [1] causes the WDTO[1] 111a of the FPGA 11 to issue an NMI to the CPU 12 (step S26)

The I2C 112 of the FPGA 11 switches the SW 15 to turn on the route connecting the FPGA to the devices 14 (step S27).

The I2C 112 of the FPGA 11 obtains log data [1] from the devices #0-#2 (steps S28-S30).

The NIF 113 of the FPGA 11 stores the obtained log data [1] into the NVRAM 13 (step S31).

The I2C 112 of the FPGA 11 switches the SW 15 to turn off the route connecting the FPGA to the devices 14 (step S32).

Expiration of the watch dog time [2] causes the WDTO[2] 111b of the FPGA 11 to issue an instruction of software rest to the CPU 12 (step S33).

The I2C 112 of the FPGA 11 switches the SW 15 to turn on the route connecting the FPGA 11 to the devices 14 (step S34).

The I2C 112 of the FPGA 11 obtains log data [2] from the devices #0-#2 (steps S35-S37).

The NIF 113 of the FPGA 11 stores the obtained log data [2] into the NVRAM 13 (step S38).

The I2C 112 of the FPGA 11 switches the SW 15 to turn off the route connecting the FPGA to the devices 14 (step S39).

Expiration of the watch dog time [3] causes the WDTO[3] 111c of the FPGA 11 to issue an instruction of hardware rest to the CPU 12 (step S40).

The I2C 112 of the FPGA 11 switches the SW 15 to turn on the route connecting the FPGA to the devices 14 (step S41).

The I2C 112 of the FPGA 11 obtains log data [3] from the devices #0-#2 (steps S42-S44).

The NIF 113 of the FPGA 11 stores the obtained log data [3] into the NVRAM 13 (step S45).

The I2C 112 of the FPGA 11 switches the SW 15 to turn off the route connecting the FPGA to the devices 14 (step S46).

The FPGA 11 determines that the hang-up of the CPU 12 is established (step S47).

The TCTL 114a of the FPGA 11 reads the obtained log data [1], [2], and [3] from the NVRAM 13 and transmits the log data [1], [2], and [3] to the FPGA 11 of the CM #1 of the normal system (step S48).

The FPGA 11 of the CM #1 stores the received log data [1], [2], and [3] into the NVRAM 13 (step S49).

The FPGA 11 of the CM #0 restarts the local CM #0 (step S50). Alternatively, the FPGA 11 may restart only the local device 14 where the failure occurs (suspect point) and the local CPU 12 where the failure propagates.

The CPU 12 of the CM #1 obtains an error log from the NVRAM 13 (step S51).

(A-3) Effects:

The above storage device (information processing apparatus) 1 according to an example of the first embodiment attains the following effects.

When the monitor 111 detects an occurrence of a failure in the processor 12, the information obtainer 112 obtains log data from the monitoring target device 14. The first storing processor 113a stores the log data obtained by the information obtainer 112 into the storing device 13. Thereby, even when the CPU is in a disable state, the log data of the monitoring target devices 14 can be obtained. Furthermore, after the CM 10 recovers from the failure or the storing device 13 is detached from the storage device 1, the log data stored in the storing device 13 can be analyzed.

The transmitter 114a transmits the log data obtained by the information obtainer 112 to another controller module 10. The second storing processor 113b of the other controller module 10 stores the log data transmitted from the transmitter 114a into the storing device 13. Thereby, the normal controller module 10 can immediately start analyzing the log data. The suspect point of the failure in the abnormal controller module 10 can be specified without detaching the abnormal controller module 10; attaching the abnormal controller module 10 to a measuring device; reproducing the disable state of the processor 12; and obtaining, by an operator, the log data. Consequently, the steps, the time, and the costs to specify the suspect point can be reduced and the suspect point can be easily specified. Furthermore, since the log data is redundantly stored in the storing devices 13 of both the normal and abnormal controller modules 10, the reliability of the collecting of the log data can be improved.

After the transmitter 114a transmits the log data to another controller module 10, the restarting processor 115 restarts the CPU 12 and the monitoring target device 14. This makes it possible to analyze the log data in the normal controller module 10 even after the log data stored in the storing device 13 is deleted by restarting the abnormal controller module 10.

At multiple timings when the processor carries out multiple recovery process of Non-Maskable Interrupt (NMI; processor preemptive process), software reset, and hardware reset, the obtaining of the log data by the information obtainer 112 and the storing of the log data by the first storing processor 113a are repeated. This makes it possible to obtain log data [1]-[3] representing the state of the monitoring target devices 14 to be monitored after the respective recovery processes, so that the suspect point can be easily specified.

(B) Modification:

The technique disclosed above is not limited to the foregoing embodiment and can be demonstrated without departing from the spirit of the first embodiment. The configuration and procedural steps may be selected, omitted, and combined according to the requirement.

The FPGA 11 of the abnormal system forwards the log data [1]-[3] to the FPGA 11 of the normal system (see, for example, step S48 of FIG. 8), but, the forwarding timing is not limited to this.

In this modification of the first embodiment, the FPGA 11 of the abnormal system stores each of the log data [1]-[3] into the NVRAM 13 and immediately after that (i.e., immediately after steps S31, S38, and S45 of FIG. 8), successively forwards each of log data [1]-[3] to the FPGA 11 of the normal system.

Then, after the hang-up of the CPU 12 is established (e.g., after step S47 of FIG. 8), the FPGA 11 of the abnormal system transmits completion notification representing that transmission of all the log data [1]-[3] is completed to the FPGA 11 of the normal system.

As the above, the storage device (information processing apparatus) 1 of the modification to the first embodiment achieves the same effects as those of the above example of the first embodiment, and further brings the following effects.

Consequently, each of the log data [1]-[3] can be individually transmitted to the CM 10 of the normal system earlier than the first embodiment, which allows the CM 10 of the normal system to start analyzing the log data earlier, so that an alert indicating that a failure occurs in foreign CM 10 can be rapidly issued.

According to the information processing apparatus, the log data of each monitoring target device can be collected even the processor is in a disable state.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising a controller communicably connected to a device to be monitored, the controller comprising:
a monitor that monitors an occurrence of a failure in a processor;
an information obtainer that obtains, when the monitor detects the occurrence of the failure, log data from the device; and
a first storing processor that stores the log data obtained by the information obtainer into a first storing device.

2. The information processing apparatus according to claim 1, further comprising a plurality of the controllers, wherein:
each controller further comprises a transmitter that transmits the log data obtained by the information obtainer to another controller included in the plurality of controllers; and
the other controller comprises a second storing processor that stores the log data transmitted from the transmitter into a second storing device.

3. The information processing apparatus according to claim 2, wherein the transmitter transmits the log data to the other controller after the processor is established to be in a disable state.

4. The information processing apparatus according to claim 2, wherein the controller further comprises a restarting processor that restarts the processor and the device after the transmitter transmits the log data to the other controller.

5. The information processing apparatus according to claim 1, wherein the controller repeats the obtaining of the log data by the information obtainer and the storing of the log data by the first storing processor at a plurality of timings.

6. The information processing apparatus according to claim 5, wherein:
the controller has a plurality of recovery functions of executing a plurality of processes including non-maskable interrupt, software reset, and hardware reset; and
the plurality of timings are timings of executing the plurality of processes.

7. A controller communicably connected to a device to be monitored, the controller comprising:
a monitor that monitors an occurrence of a failure in a processor;
an information obtainer that obtains, when the monitor detects the occurrence of the failure, log data from the device; and
a first storing processor that stores the log data obtained by the information obtainer into a first storing device.

8. The controller according to claim 7, further comprising a transmitter that transmits the log data obtained by the information obtainer to another controller communicably connected to the controller.

9. The controller according to claim 8, wherein the transmitter transmits the log data to the other controller after the processor is established to be in a disable state.

10. The controller according to claim 8, further comprising a restarting processor that restarts the processor and the device after the transmitter transmits the log data to the other controller.

11. The controller according to claim 7, wherein the controller repeats the obtaining of the log data by the information obtainer and the storing of the log data by the first storing processor at a plurality of timings.

12. The controller according to claim 11, wherein:
the controller has a plurality of recovery functions of executing a plurality of processes including non-maskable interrupt, software reset, and hardware reset; and
the plurality of timings are timings of executing the plurality of processes.

13. A method for collecting log data in an information processing apparatus including a controller communicably connected to a device to be monitored, the method comprising:
at the controller
monitoring an occurrence of a failure in a processor;
obtaining, when the occurrence of the failure is detected, the log data from the device; and
storing the obtained log data into a first storing device.

14. The method for collecting log data according to claim 13, wherein:
each information processing apparatus comprises a plurality of the controllers; and
the method further comprising:
at the controller,
transmitting the obtained log data to another controller included in the plurality of controllers; and
at the other controller,
storing the log data transmitted from the controller into a second storing device.

15. The method for collecting log data according to claim 14, further comprising:
at the controller,
transmitting the obtained log data to the other controller after the processor is established to be in a disable state.

16. The method for collecting log data according to claim 14, further comprising:
at the controller,
restarting the processor and the device after the transmitting of the obtained log data to the other controller.

17. The method for collecting log data according to claim 13 further comprising:
at the controller,
repeating the obtaining of the log data and the storing of the log data at a plurality of timings.

18. The method for collecting log data according to claim 17, wherein:
the controller has a plurality of recovery functions of executing a plurality of processes including non-maskable interrupt, software reset, and hardware reset; and
the plurality of timings are timings of executing the plurality of processes.
